(19) United States
(12) Patent Application Publication
(10) Pub. No.: US 2006/0163173 A1
(43) Pub. Date: Jul. 27, 2006

(54) Method for treating sewage and sewage treatment system in combined sewer systems

(76) Inventors: Haruhiko Suzuki, Ibaraki (JP); Yasuhito Kondo, Gunma (JP); Masahiro Iseki, Gunma (JP); Daizou Takaoka, Gunma (JP); Yasuteru Sumida, Gunma (JP)

Correspondence Address: MCDERMOTT WILL & EMERY LLP, 600 13TH STREET, N.W., WASHINGTON, DC, 20005-3096, US

(21) Appl. No.: 10/629,843

(22) Filed: Jul. 30, 2003

(30) Foreign Application Priority Data
Aug. 6, 2002 (JP) 2002-228905
Dec. 10, 2002 (JP) 2002-357879

(51) Int. Cl. C02F 1/72

(52) U.S. Cl. 210/753; 210/760; 210/192; 210/764

(57) ABSTRACT

The present invention has an object of providing a sewage treatment method and a sewage treatment system in a combined sewer system which can safely treat sewage, and in a combined sewer system where wastewater and rainwater collected flow together as the sewage in a single pipe, the sewage is electrochemically treated, i.e., electrolytically treated by use of electrodes for electrolysis to produce hypohalogenous acid, ozone or activated oxygen in the sewage. The thus produced hypohalogenous acid, ozone or activated oxygen can treat contaminants such as organic substances and coliforms present in the sewage.

### BACKGROUND OF THE INVENTION

1. Field of the Invention

The present invention relates to a method for treating sewage and sewage treatment system in a combined sewer system where wastewater and rainwater collected flow together as sewage in a single pipe.

2. Description of the Related Art

A conventional method for treating sewage and sewage treatment system 100 in a combined sewer system will be described with reference to FIG. 14. The conventional sewage treatment system 100 is composed of a combined sewer system 102 comprising a plurality of sewer pipes 101 which drain domestic and/or industrial wastewater and rainwater (hereinafter referred to collectively as “sewage”), pump station 103 serving as a transit station to transfer the sewage collected by the combined sewer system 102 to a sewage-works, and sewage-works 105 which treats the transferred sewage and discharges the treated sewage into a water area 104, e.g., river or sea, as shown in FIG. 1.

The sewer pipe 101 is normally laid underground, slanted slowly downward in a flow direction. Domestic and/or industrial wastewater is stored in a wastewater tank 106 or the like, and rainwater in a rainwater tank 107 or the like, from which they flow naturally in the sewer pipe 101 by gravity. The sewer pipe 101 is slanted under the ground to facilitate flow of the sewage by gravity, as described above, running slowly deeper in the level ground. The pump station 103 is provided at a certain depth, by which the sewage is pumped up to the vicinity of the earth surface by a pump (not shown). The sewage is then flow by gravity again in the sewer pipe 101. The sewage can be transferred in this manner eventually to the sewage-works 105.

Moreover, the sewer pipe 101 is also provided with overflow dams 108 serving as discharge ports at two or more sites. The overflow dam 108 directly discharges sewage partly or totally into a water area 104, e.g., river or sea, when the water level rises abnormally as a result of localized torrential downpour or the like beyond the capacity of the sewer pipe 101 to transfer sewage to the sewage-works 105. Therefore, it is provided with an overflow water passage 109 which directly passes the overflow water (it's called a Combined Sewer Overflow (CSO)) flowing under an abnormal condition from the dam 108 to the discharge water area 104.

The overflow water passage 109 is provided also at the pump station 103. It can also directly discharge the CSO under an abnormal condition into the discharge water area 104, to prevent calamities, e.g., flooding.

The sewage-works 105 is provided with various treatment systems, e.g., settling tank, aeration tank or chlorine-contacting tank (which are not shown), by which sewage is treated before being discharged into a water area, e.g., river or sea.

However, the sewage treatment system 100 directly discharges sewage partly or totally as the CSO under an abnormal condition into the water area 104, e.g., river or sea, when the water level rises abnormally as a result of localized torrential downpour or the like beyond the capacity of the sewage-works 105 or sewer pipe 101, by which is meant that the wastewater is directly discharged into the water area 104 in such a case. As a result, the wastewater contaminates the river or sea, causing problems that the public water area cannot be preserved.

In an attempt to prevent wastewater from being directly discharged into a river or sea, some conventional treatment systems sterilize the sewage with a directly injected or sprayed agent, e.g., disinfectant such as chlorine, at the pump station 103 or another place where sewage containing wastewater is gathered.

In such a case, however, a large quantity of disinfectant should be injected or sprayed to disinfect a large quantity of sewage all at once. Therefore, these systems need a number of disinfectant injection ports in the sewer pipe 101, and should always keep a large quantity of disinfectant at the disinfectant injection section, pump station 103 or the like for an abnormal rise of water level.

Always keeping a large quantity of disinfectant causes problems, e.g., need for complex management/maintenance of the disinfectant. It is also undesirable viewed from preservation of social environments, because the disinfectant is a hazardous material.

### SUMMARY OF THE INVENTION

It is an object of the present invention to provide a method for treating sewage safely and simply, and a sewage treatment system in a combined sewer system, in order to solve the problems involved in the conventional techniques.

More specifically, a method for treating sewage in a combined sewer system of the present invention where wastewater and rainwater collected flow together as sewage is characterized by treating the sewage with an electrochemically produced hypohalogenous acid, ozone or activated oxygen.

The method for treating sewage in the combined sewer system of the present invention is characterized in that electrolytic water containing an electrochemically produced hypohalogenous acid, ozone or activated oxygen is mixed with the sewage.

The method for treating sewage in the combined sewer system of the present invention is characterized in that the sewage is treated with a hypohalogenous acid, ozone or activated oxygen electrochemically produced therein.

The method for treating sewage in the combined sewer system of the present invention is characterized in that part or all of the sewage is held for a while, electrochemically treated to produce a hypohalogenous acid, ozone or activated oxygen, and then discharged into the sewer system.

The method for treating sewage in the combined sewer system of the present invention is characterized in that the sewage held for a while is rainwater held in a rainwater-reservoir system.

The method for treating sewage in the combined sewer system of the present invention is characterized in that the sewage in the sewer system is treated with a hypohalogenous acid, ozone or activated oxygen electrochemically produced therein, and part or all of the treated sewage is stored for a while and discharged into the sewer system.

The method for treating sewage in the combined sewer system of the present invention is characterized in that the sewage stored for a while is electrochemically treated to produce a hypohalogenous acid, ozone or activated oxygen therein, and then discharged into the upstream of the sewer system.

The method for treating sewage in the combined sewer system of the present invention is characterized in that the sewage is treated with a hypohalogenous acid, ozone or activated oxygen electrochemically produced therein at a pump station which pumps up the sewage flowing downward from the upstream of the sewer system up to the vicinity of the earth surface by a pump.

The method for treating sewage in the combined sewer system of the present invention is characterized in that the sewage is treated with a hypohalogenous acid, ozone or activated oxygen electrochemically produced therein at an overflow water passage provided in the sewer system to directly discharge the sewage as the CSO flowing under an abnormal condition into a river, sea or the like, when the water level rises abnormally.

The method for treating sewage in the combined sewer system of the present invention is characterized in that a halide or halide ion is added thereto for the electrochemical treatment.

The method for treating sewage in the combined sewer system of the present invention is characterized in that seawater is added thereto in the electrochemical treatment.

The method for treating sewage in the combined sewer system of the present invention is characterized in that the sewage is adjusted at a pH of 7 or less.

A sewage treatment system in a combined sewer system of the present invention where wastewater and rainwater collected flow together as sewage is characterized by comprising a treating means which electrochemically produces a hypohalogenous acid, ozone or activated oxygen with which the sewage is treated.

The sewage treatment system in the combined sewer system of the present invention is characterized in that the treating means mixes electrolytic water containing an electrochemically produced hypohalogenous acid, ozone or activated oxygen with the sewage.

The sewage treatment system in the combined sewer system of the present invention is characterized in that the treating means electrochemically treats the sewage to produce a hypohalogenous acid, ozone or activated oxygen therein.

The sewage treatment system in the combined sewer system of the present invention is characterized by comprising a reservoir which holds part or all of the sewage for a while, wherein the treating means electrochemically treats the sewage held in the reservoir to produce a hypohalogenous acid, ozone or activated oxygen therein, and discharges the treated sewage into the sewer system.

The sewage treatment system in the combined sewer system of the present invention is characterized in that the reservoir is a rainwater-reservoir which holds rainwater.

The sewage treatment system in the combined sewer system of the present invention is characterized in that the reservoir is composed of an auxiliary chamber which is an expanded part of the sewer pipe for the sewer system.

The sewage treatment system in the combined sewer system of the present invention is characterized in that a filter is provided between the sewer pipe and auxiliary chamber.

The sewage treatment system in the combined sewer system of the present invention is characterized in that the treating means electrochemically treats the sewage flowing in the sewer pipe to produce a hypohalogenous acid, ozone or activated oxygen therein, and in a latter stage of the treating means, there is provided a reservoir which stores part or all of the sewage flowing in the sewer pipe for a while and discharges the treated sewage into the sewer system.

The sewage treatment system in the combined sewer system of the present invention is characterized in that the treating means electrochemically treats the sewage stored in the reservoir to produce a hypohalogenous acid, ozone or activated oxygen therein, and discharges the treated sewage into the upstream of the sewer system.

The sewage treatment system in the combined sewer system of the present invention is characterized in that the reservoir is composed of a storing chamber for storing the sewage and an electrolysis chamber for electrochemically treating the sewage in the reservoir.

The sewage treatment system in the combined sewer system of the present invention is characterized in that the treating means also electrochemically treats the sewage to produce a hypohalogenous acid, ozone or activated oxygen therein at a pump station which pumps up the sewage flowing downward from the upstream of the sewer system up to the vicinity of the earth surface by a pump.

The sewage treatment system in the combined sewer system of the present invention is characterized in that the treating means electrochemically treats the sewage to produce a hypohalogenous acid, ozone or activated oxygen therein at an overflow water passage provided in the sewer system to directly discharge the sewage as the CSO flowing under an abnormal condition into a river, sea or the like, when the water level rises abnormally.

The sewage treatment system in the combined sewer system of the present invention is characterized in that the treating means is provided with means for adding a halide or halide ion to the electrochemically treated sewage.

The sewage treatment system in the combined sewer system of the present invention is characterized in that the treating means is provided with means for adding seawater to the electrochemically treated sewage.

The sewage treatment system in the combined sewer system of the present invention is characterized in that the treating means is provided with pH-adjusting means for adjusting the electrochemically treated water at a pH of 7 or less.

The sewage treatment system in the combined sewer system of the present invention is characterized in that the treating means is provided with electrodes for electrolysis, the electrodes being of bi-polar type.

The sewage treatment system in the combined sewer system of the present invention is characterized in that the treating means is provided with electrodes for electrolysis, each electrode being composed of a noble metal or conductor coated with the noble metal, carbon-based conductor or conductor coated with the carbon-based conductor, ceramic-based conductor or conductor coated with the ceramic-based conductor, or iron-based alloy or conductor coated with the iron-based alloy.

The sewage treatment system in the combined sewer system of the present invention is characterized in that the treating means is provided with a discharged water quantity sensor which senses a quantity of the sewage discharged from the discharge port at an overflow water passage provided in the sewer system to directly discharge the sewage as the CSO flowing under an abnormal condition into a river, sea or the like, when the water level rises abnormally; a water quality sensor which senses quality of the sewage discharged from the discharge port; electrodes for electrolysis; and a controller which controls current or/and voltage for electrolysis to be applied to the electrodes for electrolysis, based on externally supplied rainfall data, discharged quantity data read by the discharged water quantity sensor and water quality data read by the water quality sensor.

The sewage treatment system in the combined sewer system of the present invention is characterized in that the sewer system is composed of two or more lines, each sewer system line being provided with a discharged water quantity sensor, water quality sensor and electrodes for electrolysis; and the controller is also provided to control current or/and voltage for electrolysis to be applied to the electrodes for electrolysis, based on externally supplied rainfall data, discharged quantity data read by each discharged water quantity sensor and water quality data read by each water quality sensor.

The sewage treatment system in the combined sewer system of the present invention is characterized in that the controller transmits data from a portable terminal to a server, which treats the data by comparing them with meteorological data, and transmits necessary control signals selected from the past and present data and anticipated weather condition changes back to the portable terminal, to control current or/and voltage for electrolysis to be applied to the electrodes for electrolysis.

### BRIEF DESCRIPTION OF THE DRAWINGS

FIG. 1 outlines one embodiment of the sewage treatment system of the present invention.

FIG. 2 outlines one embodiment of the sewer pipe in the sewage treatment system shown in FIG. 1.

FIG. 3 shows the test results demonstrating the sterilization effect of the electrolytic water.

FIG. 4 shows the test results demonstrating the effect of current density on effective chlorine generation rate.

FIG. 5 shows the test results demonstrating the effect of electrolysis time on the sterilization effect.

FIG. 6 outlines another embodiment of the sewer pipe, different from that shown in FIG. 2.

FIG. 7 outlines still another embodiment of the sewer pipe, different from that shown in FIG. 2.

FIG. 8 outlines another embodiment of the sewer pipe, different from that shown in FIG. 2.

FIG. 9 outlines still another embodiment of the sewer pipe, different from that shown in FIG. 2, and an embodiment of the reservoir inside.

FIG. 10 outlines still another embodiment of the sewer pipe, different from that shown in FIG. 2, and another embodiment of the reservoir inside.

FIG. 11 outlines still another embodiment of the sewer pipe, different from that shown in FIG. 2, and still another embodiment of the reservoir inside.

FIG. 12 outlines the sewage treatment system shown in FIG. 1.

FIG. 13 outlines another embodiment of the sewage treatment system.

FIG. 14 outlines a conventional sewage treatment system.

### DETAILED DESCRIPTION OF THE PREFERRED EMBODIMENTS

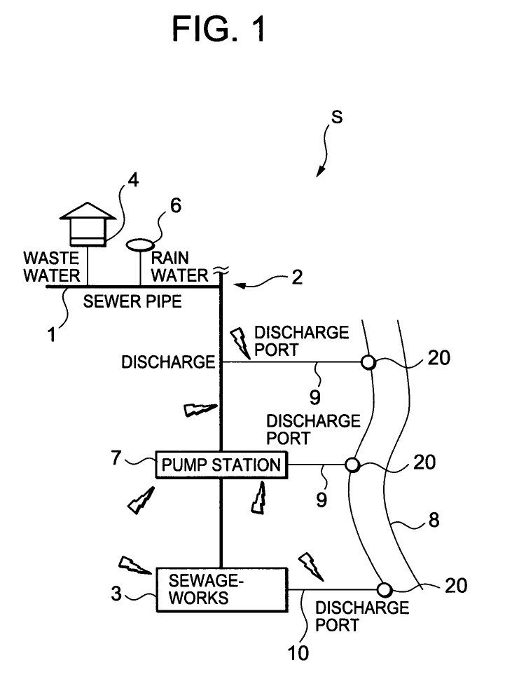

The preferred embodiments of the present invention will be described with reference to the drawings. First, one embodiment of the present invention will be described with reference to one or more drawings of FIGS. 1 to 11. FIG. 1 outlines the sewage treatment system S for realizing the method of the present invention for treating sewage in a combined sewer system. The sewage treatment system S in this embodiment is intended to treat domestic and/or industrial wastewater and rainwater (hereinafter referred to collectively as “sewage,” because the system brings the similar effect when only wastewater or rainwater is to be treated).

The sewage treatment system S is for a combined sewer system 2 comprising a plurality of sewer pipes 1, in which both wastewater and rainwater will flow. The combined sewer system 2 transfers sewage to a sewage-works 3 by the sewer pipes 1. Each sewer pipe 1 is laid underground, slanted slowly downward in a flow direction. Domestic and/or industrial wastewater is stored in a wastewater tank 4 or the like, and rainwater in a rainwater tank 6 or the like, from which they flow naturally in the sewer pipe 1 by gravity.

The sewer pipe 1 is slanted under the ground to facilitate flow of the sewage to the sewage-works 3 by gravity, as described above, running slowly deeper in the level ground. Therefore, a pump station 7 is provided at a certain depth, by which the sewage is pumped up to the vicinity of the earth surface by a pump (not shown). The sewage is then flow by gravity again in the downstream sewer pipe 1. The sewage can be transferred in this manner eventually to the sewage-works 3.

Moreover, the combined sewer system 2 is also provided with an overflow water passage 9, to directly discharge sewage partly or totally as the CSO flowing under an abnormal condition into a water area 8, e.g., river or sea, when the water level rises abnormally as a result of localized torrential downpour or the like beyond the capacity of the sewer pipe 1 or sewage-works 3. The overflow water passage 9 is normally provided with an overflow dam (not shown) at a point at which it crosses each sewer pipe 1. The sewage overflowing from the sewer pipe 1 top at the overflow dam can be discharged through the overflow water passage 9 into a discharge water area 8 from a discharge port 20 provided on the discharge water area 8 side.

The overflow water passage 9 is provided also at the pump station 7. It can also directly discharge the CSO under an abnormal condition into the discharge water area 8, to prevent calamities, e.g., flooding.

The sewage-works 3, which is a part of the combined sewer system 2 comprising a plurality of sewer pipes 1, is a system which treats the sewage flowing thereto. The sewage-works 3 in this embodiment electrochemically (electrolytically) treats the sewage with electrodes 11 and 12 for electrolysis (described in detail later). It is also provided with various treatment systems, e.g., activated sludge tank for biological treatment, settling tank, aeration tank or chlorine-contacting tank (which are not shown), by which sewage is treated before being discharged into the water area 8, e.g., river or sea, through a discharge pipe 10.

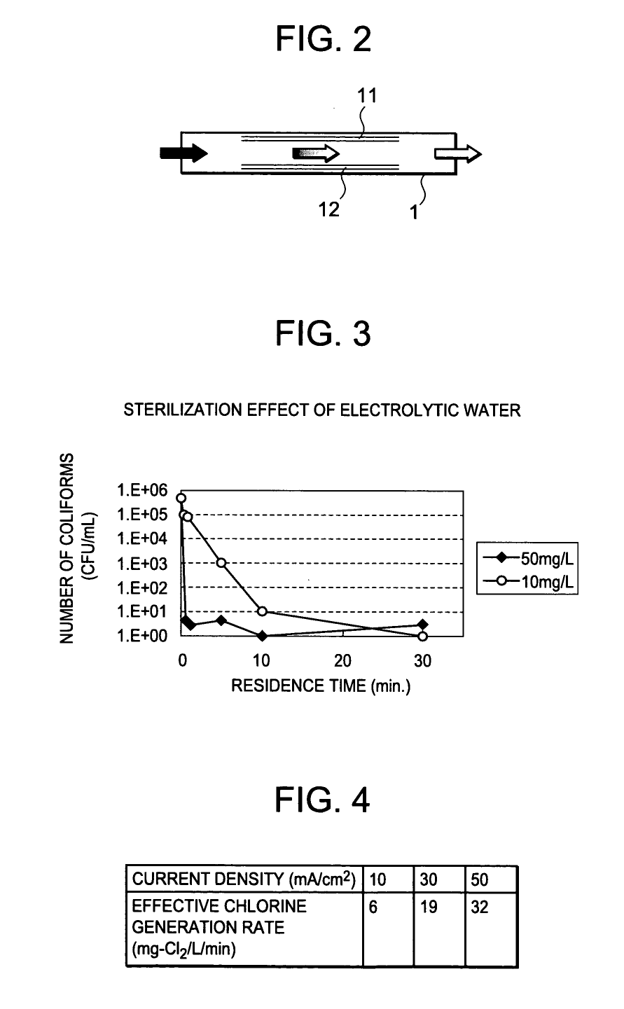

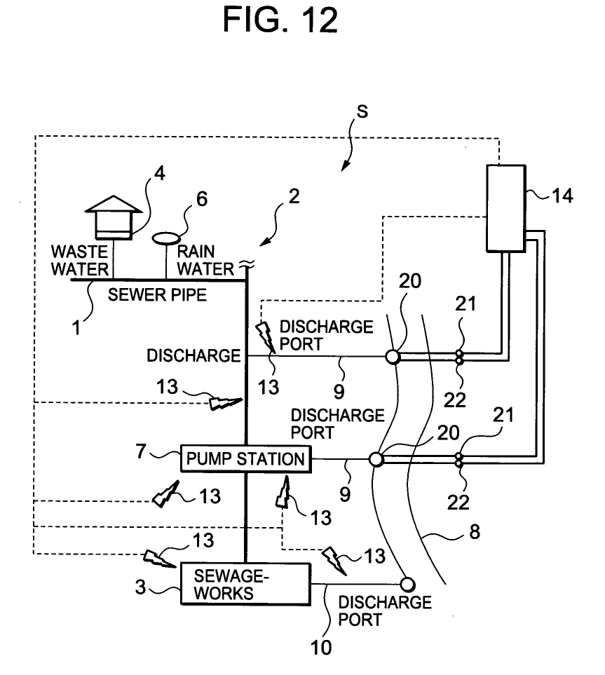

The sewer pipe 1 is provided with the electrodes 11 and 12 for electrolysis as the treatment means shown in FIG. 2. They are positioned to face each other, immersed in the sewage at least party, and connected to a power source 13 (shown only in FIG. 12, later described) for power supply. A controller 14 (also shown only in FIG. 12, later described) is connected to the power source 13 to control potential between the electrodes 11 and 12.

Each of these electrodes 11 and 12 is composed of a noble metal, e.g., platinum (Pt) or a mixture of platinum and iridium (Ir), or insoluble conductor coated with the noble metal. They may be also composed of a carbon-based conductor or conductor coated with the carbon-based conductor, ferrite-containing ceramic-based conductor or conductor coated with the ceramic-based conductor, or iron-based alloy, e.g., stainless steel, or conductor coated with the iron-based alloy.

The combined sewer system 2 of the present invention having the above structure stores, for a while, domestic and/or industrial wastewater in the wastewater tank 4 or the like, and rainwater in the rainwater tank 6 or the like, from which they flow naturally in the slanted sewer pipe 1 by gravity.

As described above, the sewer pipe 1 is provided with the electrodes 11 and 12 for electrolysis, which are supplied with power via the controller 14 periodically, continuously or as required from the power source 13. As a result, the sewage flowing downward in the sewer pipe 1 is electrically (or electrolytically in this case) treated by the aid of the electrodes 11 and 12 for electrolysis.

In the electrolysis treatment, a positive potential is applied to the electrode 11 and negative potential to the electrode 12, when the power source is switched on by the controller 14, with the electrode 11 serving as the anode and electrode 12 as the cathode. Application of the potential decomposes an organic substance present in the sewage, in particular, domestic and/or industrial wastewater, into nitric ion as a nitric nitrogen, ammonia or ammonium ion as ammonia nitrogen, carbon dioxide and water (Reaction A). Reaction A will be described below:
Organic substance→NO₃⁻+NH₃+CO₂+H₂O Reaction A

The electrolysis treatment can efficiently convert the organic substance in the sewage (domestic and/or industrial wastewater) into the nitric nitrogen and ammonia nitrogen.

The chloride ion present in the sewage releases the electron to form chlorine (Reaction B) on the electrode 11 for electrolysis (anode). The chlorine is dissolved in water to form hypochlorous acid as a hypohalogenous acid (Reaction C). The hypochlorous acid formed reacts with the ammonia (ammonium ion) formed in the sewage by Reaction A, and then undergoes 2 or more reactions to be eventually converted into nitrogen gas (Reaction D). Reactions B to D, which also produce ozone or active oxygen, are described below.
NaCl→Na⁺+Cl⁻
2Cl⁻→Cl₂+2e⁻ Reaction B
Cl₂+H₂O HClO+HCl Reaction C
NH₃+HClO→NH₂Cl+H₂O
NH₂Cl+HClO→NHCl₂+H₂O
NH₂Cl+NHCl₂→N₂↑+3HCl Reaction D

Moreover, the ammonia (ammonium ion) present in the sewage reacts with the ozone or active oxygen formed on the electrode 11 for electrolysis (anode) (Reaction E), to be denitrogenated into nitrogen gas.
Reaction E 2NH₃(aq)+3(O)→N₂↑+3H₂O

Thus, the organic substance present in the sewage can be converted into nitrogen gas via nitric, nitrous and ammonia nitrogen.

Moreover, chlorine or hypochlorous acid formed in the vicinity of the electrode 11 as the anode, as described above, can sterilize microorganisms, e.g., coliforms, present in the sewage flowing over the electrode 11.

It is possible to keep the hypohalogenous acid, ozone or active oxygen more oxidative in the electrochemically (or electrolytically) treated sewage, when the sewage is adjusted at a pH of 7.0 or less by a pH-adjusting means (not shown), and hence to enhance efficiency of the sewage treatment.

To the sewage, there may be added a halide ion (e.g., chloride, fluoride, bromide or iodide ion) or compound containing a halide ion (e.g., potassium or sodium chloride), in order to more efficiently treat the sewage for sterilization and treatment of the nitrogen compound. For example, chlorine, when used, can bring a higher sterilization effect, when present in the sewage at around 50 mg/L as effective chlorine concentration. In this case, chloride ion concentration of the sewage can be increased by adding seawater, in place of or in addition to chlorine, to the sewer system 2 in the vicinity of the discharge port 20. This concept improves usefulness of the system, because seawater can be incorporated to increase chlorine concentration.

The test results given in FIG. 3 show changed number of coliforms group in the sewage treated by the aid of the platinum/iridium electrodes 11 and 12. In this test, electrolytic water prepared beforehand by electrolysis was added to a sewage sample, which was a solution kept at pH of 6.9, COD of 123 mg/L and coliforms of 2.5×10⁵ CFU/mL. Two types of samples were prepared, where the electrolytic water was added to the sewage sample to have an initial effective chlorine concentration of 10 mg/L for one and 50 mg/L for the other.

As shown, number of the bacteria decreases to the order of 1 digit in around 1 minute in the sample having an effective chlorine concentration of 50 mg/L, and to the order of 5,000 in 5 minutes in the sample having an effective chlorine concentration of 10 mg/L. It is thus demonstrated that the sample prepared to have an effective chlorine concentration of 50 mg/L can sterilize coliforms very quickly, within 1 minute to decrease coliforms to 3,000 CFU/mL as the so-called effluent standard.

Thus, sterilization of the sewage with an electrochemically (or electrolytically) formed hypohalogeneous acid can reduce organic substances and contaminants, e.g., coliforms, present in the sewage. Therefore, the sewage of reduced environmental load can be discharged in the water area 8, e.g., river or sea.

Moreover, it is demonstrated that a very high sterilization effect can be realized, when the sewage is treated with hypohalogenous acid, ozone or activated oxygen immediately after it is electrochemically (or electrolytically) produced. This treatment should cause no environmental problems, since it sterilizes the sewage electrochemically without using any agent.

Moreover, an organic substance or contaminant, e.g., coliforms, can be removed without adding any agent, e.g., disinfectant, to the sewage. This dispenses with a system for storing an agent, e.g., disinfectant, and can avoid risk associated with storing an agent.

Still more, the addition of a halide or halide ion in the sewage can accelerate production of a hypohalogenous acid in the electrochemical (or electrolytic) treatment, to further improve efficiency of the sewage treatment, as discussed above.

FIG. 4 shows the test results demonstrating the effect of current density on effective chlorine generation rate, where 0.5L of electrolytic water, prepared in an electrolytic tank (not shown) to contain sodium chloride at 3.3%, was electrolyzed by the aid of the platinum/iridium electrodes 11 and 12. Each electrode had an electrode area of 16 cm².

It is found that effective chlorine generation rate is 6 mg-Cl₂/L/minute at a current density of 10 mA/cm², 19 mg-Cl₂/L/minute at 30 mA/cm², and 32 mg-Cl₂/L/minute at 50 mA/cm².

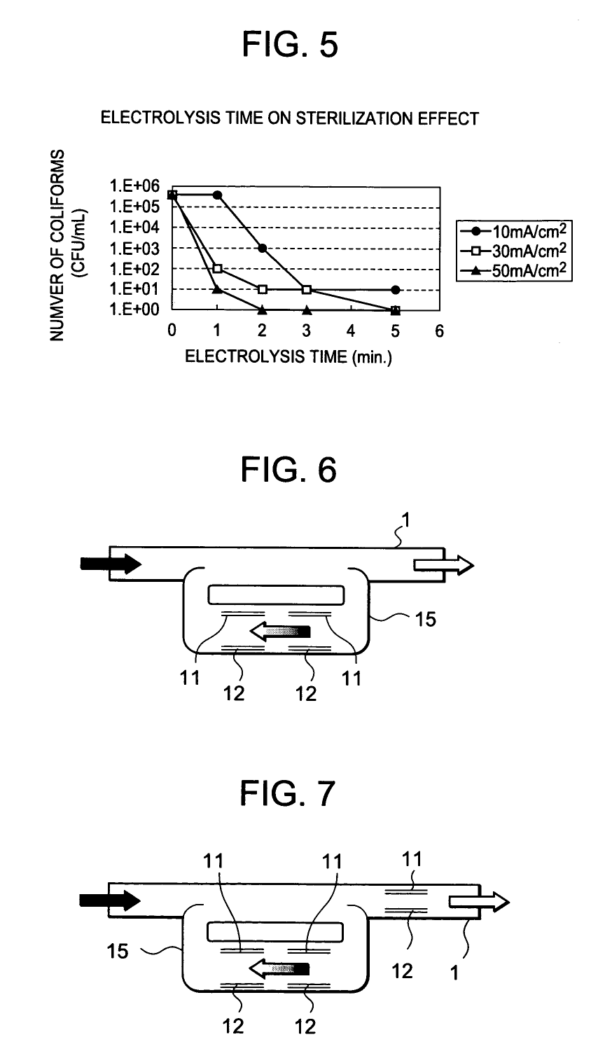

On the other hand, FIG. 5 shows the test results demonstrating the effect of electrolysis time on the sterilization effect, where 0.5L of a synthetic sewage sample, prepared in an electrolytic tank (not shown) to contain sodium chloride at 3.3% and COD of 120 mg/L and incorporated with coliforms at 4.1×10⁵ CFU/mL, was directly electrolyzed by the aid of the platinum/iridium electrodes 11 and 12 each having an electrode area of 16 cm². Current density was set at 10, 30 or 50 mA/cm² in the electrolysis treatment.

It is found that a high sterilization effect can be realized in short 1 minute or so even with a synthetic sewage sample directly incorporated with coliforms, when it is electrolyzed at a high current density, as well as with the sewage sample incorporated with electrolytic water prepared beforehand.

In order to further extend residence time of the sewage in the sewer pipe 1 and thereby to carry out the electrolytic treatment more efficiently, an electrolytic tank (reservoir) 15 containing the electrodes 11 and 12 for the electrolytic treatment may be provided on the sewer pipe 1, as shown in FIG. 6.

This design allows part of the sewage passing through the sewer pipe 1 to be circulated and hence held for a while in the electrolytic tank 15, with the result that a hypohalogenous acid, ozone or activated oxygen can be produced more efficiently by electrochemically (or electrolytically) treating the sewage held in the tank. Therefore, it allows a hypohalogenous acid, ozone or activated oxygen to be produced efficiently, even when a halide ion is present in the sewage at a relatively low concentration, to improve sewage treatment capacity. The sewage treatment can be continued even in the downstream side of the sewer pipe 1 until the hypohalogenous acid, ozone or activated oxygen produced in the electrolytic tank 15 disappears by circulating it back to the sewer pipe 1. The system shown in FIG. 6 circulates the electrolytic water produced in the electrolytic tank 15 back to the upstream side of the sewer pipe 1. However, the system is not limited to the above configuration, and the electrolytic water may be circulated back to the downstream side.

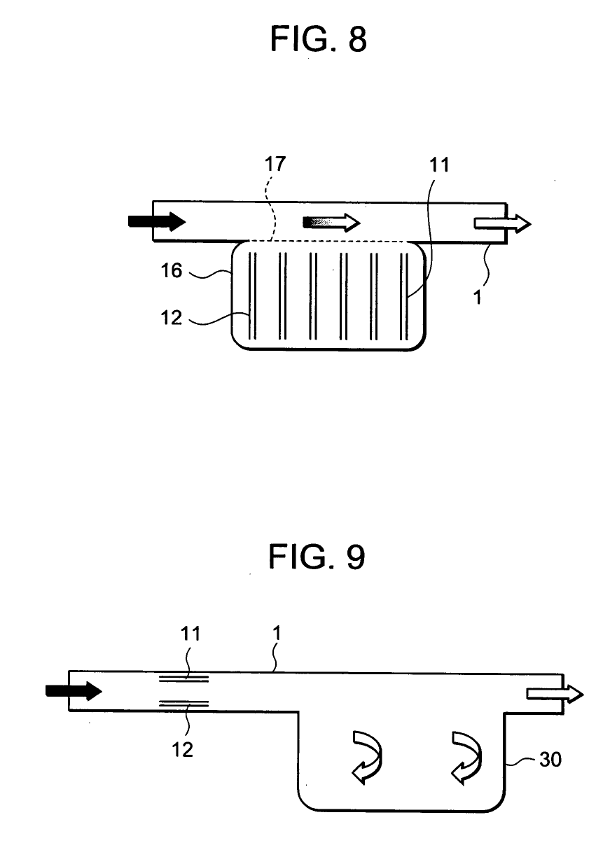

In this specific embodiment, the electrolytic treatment is carried out in the electrolytic tank 15 by connecting the tank 15 to the sewer pipe 1 to hold part of the sewage in the sewer pipe 1 for a while. However, the sewage flowing in the sewer pipe 1 can be held by other configurations. For example, the electrolytic treatment can be carried out for part of the sewage held in an auxiliary chamber formed by expanding part of the sewer pipe 1, as shown in FIG. 8, to produce a hypohalogenous acid, ozone or activated oxygen in the sewage. This configuration can bring the similar effect for the sewage treatment.

The auxiliary chamber configuration by expanding part of the sewer pipe 1 is structurally simpler and hence more useful than the one with the electrolytic tank 15 separately formed on the sewer pipe 1.

Moreover, the sewage can be also electrolytically treated within the sewer pipe 1 other than in the electrolytic tank 15 by providing another electrolytic tank 15 on the sewer pipe 1 and other electrodes 11 and 12 for electrolysis therein, as shown in FIG. 7. This configuration can electrolytically treat sewage more efficiently, and also remove a contaminant, e.g., coliforms, present in the sewage.

Still more, a filter 17 may be provided between the auxiliary chamber 16, formed by expanding part of the sewer pipe 1, and sewer pipe 1 to restrict movement of solids, as shown in FIG. 8. The filter prevents the solids present in the sewage flowing downward in the sewer pipe 1 from entering the auxiliary chamber 16 and hence from depositing on the electrodes 11 and 12 in the chamber. Therefore, it prevents short circuit of the electrodes 11 and 12, which makes the electrolysis treatment difficult.

Another concept to improve efficiency of the sewage treatment involves a reservoir 30 for storing, for a while, the sewage electrochemically treated by the aids of the electrodes 11 and 12 provided in the sewer pipe 1, as shown in FIG. 9. In this case, the sewage can be stored in the reservoir 30 for a while, after being electrochemically (or electrolytically) treated by the aids of the electrodes 11 and 12. This design allows the hypohalogenous acid, ozone or activated oxygen formed by the aids of the electrodes 11 and 12 in the sewer pipe 1 to be stored in the reservoir 30, when it remains unused for the treatment of an organic substance or contaminant to be removed, e.g., coliforms.

As a result, the reactions between the remaining hypohalogenous acid, ozone or activated oxygen and contaminant to be removed can be continued in the reservoir 30, to increase the residence time and thereby to realize the efficient sewage treatment. The sewage stored in the reservoir 30 is returned back to the sewer pipe 1 by, e.g., overflowing after being stored in the tank for a certain time. When the hypohalogenous acid, ozone or activated oxygen still remains in the sewage flowing out of the reservoir 30, the sewage returned back to the sewer pipe 1 will be continuously treated in the downstream until it disappears.

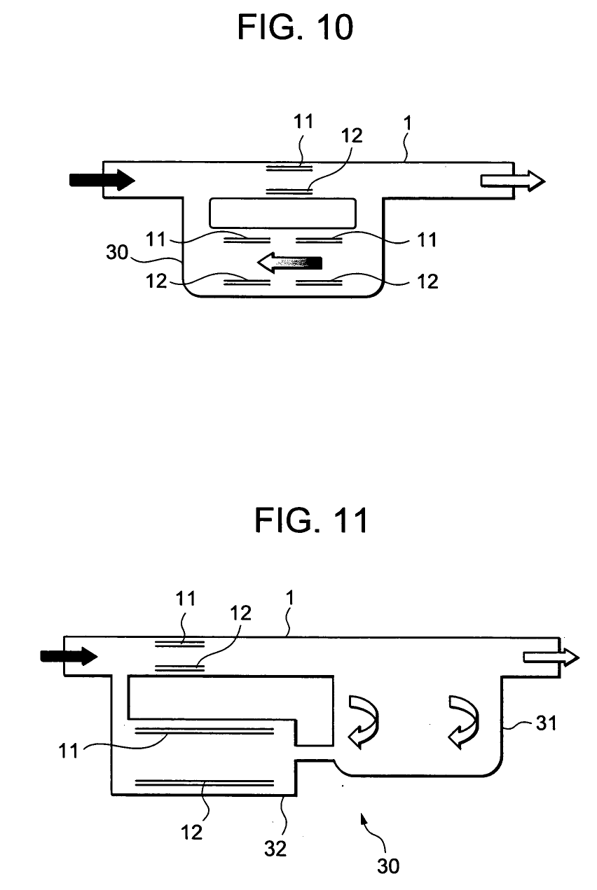

The reservoir 30 shown in FIG. 9 may be further provided with electrodes 11 and 12 for electrochemical (or electrolytic) treatment of the sewage, as shown in FIG. 10. In this case, the electrochemical (electrolytic) treatment should have a longer residence time than in the configuration shown in FIG. 9.

In the above configuration, part of the hypohalogenous acid produced in the sewer pipe 1 by the aid of the electrodes 11 and 12 for electrolysis is stored in the reservoir 30 and used to treat a contaminant to be removed from the sewage. It remains in the reservoir 30 after it is reduced to the halide ion. It is therefore possible to produce the hypohalogenous acid from the halide ion remaining in the reservoir 30 as the starting material, when the sewage is electrochemically (or electrolytically) treated in the tank by the aid of the electrodes 11 and 12. This should accelerate production of the hypohalogenous acid in the reservoir 30, and further improve sewage treatment capacity, because the hypohalogenous acid can be efficiently produced even at a relatively low concentration of the halide ion in the sewage to be treated.

In the embodiment shown in FIG. 10, the sewage treated by the aid of the electrodes 11 and 12 for electrolysis in the reservoir 30 while it is stored therein is circulated back to the upstream of the sewer pipe 1. Therefore, it is possible to pass, together with the sewage, the hypohalogenous acid produced in the reservoir 30 by the aid of the electrodes 11 and 12 for electrolysis back to the upstream of the sewer pipe 1 provided with the electrodes 11 and 12, after it is used to treat a contaminant to be removed from the sewage in the reservoir 30 and reduced to the halide ion. Therefore, the halide ion remaining in the sewage can be effectively utilized to treat the sewage.

The reservoir 30 shown in FIG. 10 may be divided into a storing chamber 31 for storing the sewage and electrolytic chamber 32 for electrochemically (or electrolytically) treating the sewage, as shown in FIG. 11.

This configuration allows the sewage electrochemically (or electrolytically) treated in the sewer pipe 1 by the aid of the electrodes 11 and 12 for electrolysis to be stored in the storing chamber 31 for a while and then passed to the electrolytic chamber 32. Therefore, the sewage can be passed to the electrolytic chamber 32 provided with the electrodes 11 and 12 for electrolysis at a relatively low concentration of a contaminant to be removed, after it is stored in the storing chamber 31, which provides a sufficient time for the reaction of the remaining hypohalogenous acid, ozone or activated oxygen with the contaminant remaining in the sewage.

As a result, This configuration allows the sewage to be electrochemically treated in the electrolytic chamber 32 by the aid of the electrodes 11 and 12 for electrolysis at a relatively low concentration of a contaminant to be removed, which can cause electrolysis efficiency, and also the halide ion to be used as the starting material for the hypohalogenous acid, after it is used for treatment of the contaminant. Therefore, it can electrolytically treat the sewage at a relatively high electrolysis efficiency, and the electrolytic chamber 32 can produce the hypohalogenous acid, ozone or activated oxygen at a relatively high concentration, to further improve efficiency of the sewage treatment.

The treated sewage is circulated back to the upstream of the sewer pipe 1 provided with the electrodes 11 and 12 for electrolysis, as is the case with the embodiment shown in FIG. 10. Therefore, it is possible to pass the halide ion present in the sewage back to the upstream of the sewer pipe 1 in a similar manner, to effectively utilize the halide ion for the sewage treatment.

In each of the above embodiments, the electrodes 11 and 12 for electrolysis are preferably of bi-polar type, shown in FIG. 8. The bi-polar type can secure a larger number of the electrodes for electrolysis for unit volume of the sewage to be treated, and hence further enhance sewage treatment efficiency. Moreover, it can work with a much reduced number of the terminals, to enhance reliability of the system as a whole. Therefore, a hypohalogenous acid, ozone or activated oxygen can be produced more efficiently during the electrolytic sewage treatment. As a result, a sufficient quantity of hypohalogenous acid can be produced at the site where the electrodes 11 and 12 for electrolysis are provided, even when the sewage flows downward in the sewer pipe 1 at a high speed, to treat the sewage eff2iciently.

This embodiment depends on electrochemical (or electrolytic) procedure for the sewage treatment, as described above, and may additionally include ultrasonic treatment.

As described above, the sewage is transferred to the sewage-works, after or while it is electrochemically (or electrolytically) treated to sufficiently remove a contaminant, e.g., organic substance or coliforms, through the downstream sewer pipe 1 and pump station 7. It can be discharged into the water area 8 via the discharge pipe 10, after being treated again in the plant 3. The sewage is transferred to the sewage-works 3 after being treated in the sewer pipe 1, to reduce the treatment load in the plant 3, and hence treated efficiently in the whole system.

In this embodiment, the electrodes 11 and 12 for electrolysis are provided in the sewer pipe 1 to treat the sewage flowing downward in the sewer pipe 1. The electrodes 11 and 12 may be additionally provided at the pump station 7 to further treat the sewage before transferring it to the sewage-works 3. In this case, the sewage can be electrochemically (or electrolytically) treated in the sewage-works 3 as an existing system, to simplify the treatment system.

Moreover, the electrodes 11 and 12 may be provided also at the overflow water passage 9, in addition to those provided in the sewer pipe 1.

Part or all of the sewage is directly discharged as the CSO into the water area 8, e.g., river or sea, via the overflow water passage 9, when the water level rises abnormally as a result of localized torrential downpour or the like beyond the capacity of the sewer pipe 1 or sewage-works 3. The overflow water passage 9 can treat the CSO, when provided with the electrodes 11 and 12 for electrolysis, while it is passing through the passage 9. The treatment efficiency can be further enhanced, when at least two of the above embodiments are combined.

A conventional system involves a problem in that a sewage, which may include rainwater, is discharged without being treated into the water area 8 as CSO flowing under an abnormal condition. On the other hand, the system of the present invention can treat CSO flowing under an abnormal condition in the overflow water passage 9 before it is discharged into a river or the like. This CSO flowing under an abnormal condition cannot be treated by the sewage-works 3. Therefore, it can discharge sewage of low environmental load into a river or the like even the water level abnormally rises, and keep the public water area preserved.

The sewage treatment system S of the present invention may be provided with a discharged water quantity sensor 21 which senses a quantity of the sewage and water quality sensor 22 which senses quality of the sewage at the discharge port, provided in the overflow water passage 9, from which the sewage is discharged into the water area 8, as shown in FIG. 12. These water quantity sensor 21 and water quality sensor 22 are connected to a controller 14 via a portable terminal (not shown) or the like, where the controller 14 works as a server to which the power source 13 is connected to supply power to the electrodes 11 and 12 for electrolysis.

Moreover, the controller 14 can be supplied from the outside with rainfall data in the area in which the sewage treatment system S is located. The power source 13 which supplies power to the electrodes 11 and 12 for electrolysis may be controlled, based on the rainfall data, and those data read by the discharged water quantity sensor 21 and water quality sensor 22.

The power source 13 can be controlled to increase electrolysis current and/or voltage, when the level of local rainfall or that read by the discharged water quantity sensor 21 is higher than a given level, or the level read by the water quality sensor 22 is lower than the effluent standard. So is vice versa, it can be controlled to decrease electrolysis current and/or voltage, when the level of local rainfall or that read by the discharged water quantity sensor 21 is lower than a given level, or the level read by the water quality sensor 22 satisfies the effluent standard.

Therefore, the system can control efficiency of electrolysis by the aid of the electrodes 11 and 12 for electrolysis, depending on the sewage conditions in the overflow water passage 9, thereby allowing the electrochemical treatment of the sewage to be carried out efficiently and improving treatment efficiency for power consumption.

Moreover, the controller receives the data from, or transmits the data to, the discharged water quantity sensor 21 and water quality sensor 22 via the portable terminal. As a result, the system can collect the data regarding a discharged water quantity and a water quality at the discharge port 20 by the portable terminal provided at the discharge port 20 in the overflow water passage 9, thereby simplifying the system structure and management works.

Moreover, the controller 14 as a server can be supplied from the outside with meteorological data, treats the data regarding a discharged water quantity and a water quality at the discharge port 20, inputted by the portable terminal, by comparing them with the meteorological data, and transmits necessary control signals incorporating anticipated weather condition changes back to the portable terminal, to control current or/and voltage for electrolysis to be applied to the electrodes 11 and 12 for electrolysis. This can simplify the system structure.

In this embodiment, the sewage treatment in the combined sewer system 2 is described for one line. However, the data, e.g., those regarding a discharged water quantity and a water quality at the discharge port 20, for the combined sewer system 2 composed of 2 or more lines can be handled in a centralized manner by a central processing unit, and, at the same time, they can be treated by comparing them with the meteorological data, to control current or/and voltage for the electrodes 11 and 12 for electrolysis for each line in the combined sewer system 2. This system can control 2 or more sets of the electrodes 11 and 12 for the combined sewer system 2 extending over a wide area in a centralized manner by a single controller, thereby further simplifying the system structure.

In each of the above embodiments, the sewage is electrolytically treated directly by the aid of the electrodes 11 and 12 for electrolysis in the sewer pipe 1, overflow water passage 9 or the like, as described above. However, it may be otherwise treated by injecting electrolytic water produced separately by electrolysis into the sewer pipe 1 or overflow water passage 9.

In this case, the overflow water passage 9 can be directly supplied with electrolytic water electrochemically produced for a relatively long time to contain a hypohalogenous acid, ozone or activated oxygen at a relatively high concentration, with the result that the untreated CSO can be treated efficiently.

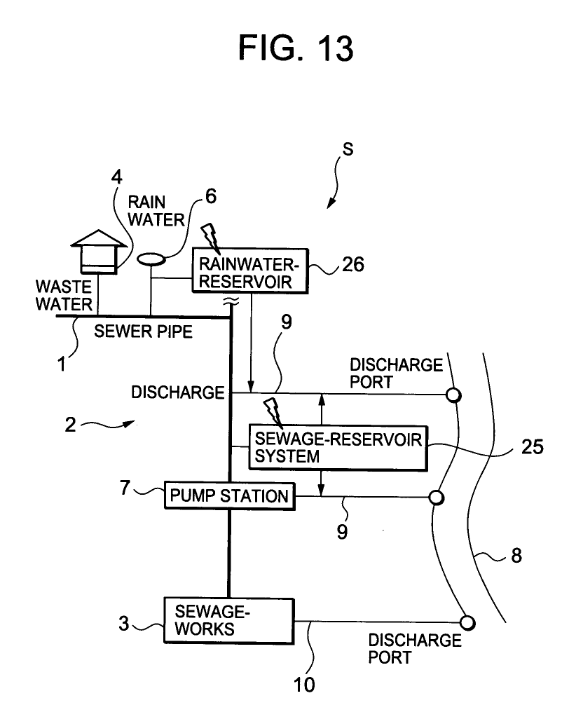

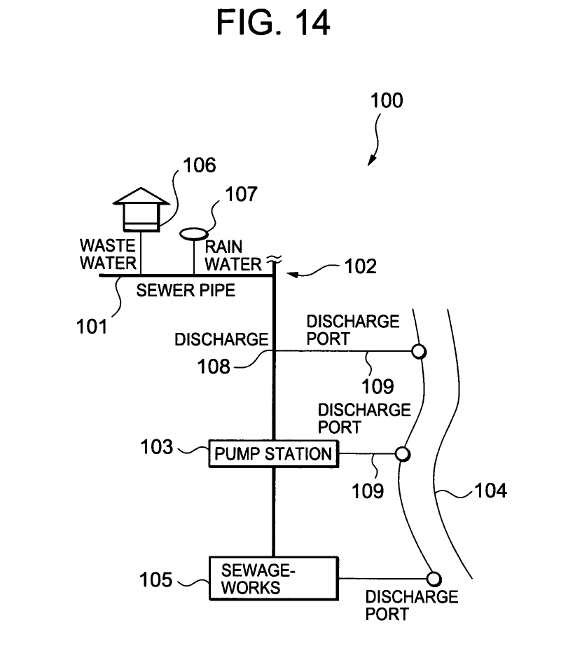

The above system can be provided with a sewage reservoir system 25 for storing the sewage for a while or rainwater-reservoir 26 for storing rainwater, as shown in FIG. 13, where the sewage or rainwater is electrolyzed by the aid of the electrodes 11 and 12 to transform the sewage or rainwater into electrolytic water containing a hypohalogenous acid, ozone or activated oxygen at a high concentration. This dispenses with electrolytic water specifically prepared by electrolyzing service water or the like, to simplify the system structure and, at the same time, treat the sewage without increasing an effluent quantity.

Rainwater stored in the rainwater-reservoir 26 can be electrochemically (or electrolytically) treated efficiently to produce a hypohalogenous acid, ozone or activated oxygen, because of its relatively low contaminant concentration. Therefore, sewage treatment efficiency can be further enhanced.

As described in detail above, the combined sewer system of the present invention treats a combined stream of wastewater and rainwater with an electrochemically produced hypohalogenous acid, ozone or activated oxygen to reduce an organic substance and contaminant, e.g., coliforms present in the combined sewage. As a result, the sewage can be discharged into a river or sea after being treated to reduce the environmental load.

The hypohalogenous acid, ozone or activated oxygen, when used immediately after it is electrochemically produced, can bring a very high sterilization effect. Treatment of the sewage by an electrochemical procedure instead of agent causes no environmental problem.

Moreover, the present invention can treat the sewage to remove an organic substance or contaminant, e.g., coliforms, without adding any agent, e.g., disinfectant. This dispenses with a system for storing an agent, e.g., disinfectant, and can avoid risk associated with storing an agent.

Still more, the present invention mixes electrolytic water containing an electrochemically produced hypohalogenous acid, ozone or activated oxygen with the sewage, to directly treat the sewage with the electrolytic water.

Still more, the present invention treats the sewage with a hypohalogenous acid, ozone or activated oxygen electrochemically produced therein, dispensing with electrolytic water specifically prepared by electrolyzing service water or the like, to simplify the system structure. The sewage itself is electrochemically treated, in place of service water separately supplied, to produce a hypohalogenous acid, ozone or activated oxygen with which the sewage is to be treated, thereby avoiding a problem of increasing an effluent quantity beyond the necessary level.

Still more, the present invention electrochemically treats part or all of the sewage stored in the reservoir for a while to produce a hypohalogenous acid, ozone or activated oxygen, and passes the treated sewage in the sewer pipe, thereby extending electrochemical treatment time to further increase production of the hypohalogenous acid, ozone or activated oxygen. This also should enhance sewage treatment capacity.

Still more, providing the rainwater-reservoir exclusively for rainwater allows the water of relatively low contaminant concentration to be electrochemically treated to produce a hypohalogenous acid, ozone or activated oxygen therein more efficiently, thereby further enhancing sewage treatment capacity.

Still more, forming an auxiliary chamber as the reservoir by expanding part of the sewer pipe allows the sewage to be held therein for a while without providing a special holding device, thereby simplifying the system structure. At the same time, holding part of the sewage in the auxiliary chamber extends electrolytic treatment time, thereby further increasing production of a hypohalogenous acid, ozone or activated oxygen, and enhancing sewage treatment capacity.

Still more, providing a filter between the sewer pipe and auxiliary chamber prevents solids from entering the auxiliary chamber, thereby avoiding short circuit of the electrodes during the electrochemical treatment process, which makes the treatment difficult.

Still more, the present invention treats the sewage with a hypohalogenous acid, ozone or activated oxygen electrochemically produced therein, and discharges the treated sewage into the sewer pipe after storing part or all of the treated sewage, thereby extending time for treating the sewage with the hypohalogenous acid, ozone or activated oxygen, and hence realizing the effective sewage treatment.

Still more, the present invention treats the sewage stored for a while to produce a hypohalogenous acid, ozone or activated oxygen therein, thereby extending electrolytic treatment time. As a result, the hypohalogenous acid produced in the sewage is used to treat a contaminant to be removed from the sewage, and reduced into the halide ion, which can be used, after being stored, as the starting material for the hypohalogenous acid while it is electrochemically treated, thereby further increasing production of the hypohalogenous acid, and enhancing sewage treatment capacity.

Still more, the sewage is electrochemically treated, after being stored for a while, and passed back to the upstream side of the sewer pipe. The hypohalogenous acid produced by the electrochemical treatment is used to treat a contaminant to be removed from the sewage, and passed back to the upstream side of the sewer pipe in a similar manner after being reduced into the halide ion, thereby effectively utilizing the halide ion as the starting material for the hypohalogenous acid to be electrochemically produced.

Still more, providing the reservoir divided into a storing chamber for storing the sewage and electrolytic chamber for electrochemically treating the sewage to be treated in the storing chamber with a hypohalogenous acid, ozone or activated oxygen and further in the electrolytic chamber. Therefore, the sewage can be electrochemically treated while it is relatively low in contaminant concentration. At the same time, the halide ion as the starting material for the hypohalogenous acid is contained in the sewage, thereby enhancing electrolytic efficiency and efficiency of producing the hypohalogenous acid, ozone or activated oxygen.

Therefore, the hypohalogenous acid, ozone or activated oxygen can be produced at a relatively high concentration, thereby further enhancing sewage treatment efficiency.

Still more, the present invention electrochemically treats the sewage at the pump station, where the sewage flowing downward from the upstream side of the sewer pipe is pumped up to the vicinity of the earth surface by a pump, to produce, in the sewage, a hypohalogenous acid, ozone or activated oxygen with which the sewage is treated, thereby further enhancing sewage treatment efficiency. The electrochemical treatment of the sewage at an existing plant simplifies the system structure.

Still more, the present invention electrochemically treats the sewage to produce a hypohalogenous acid, ozone or activated oxygen therein at the overflow water passage, which directly discharges the sewage into a river or the like as the CSO flowing under an abnormally condition when the water level abnormally rises. Therefore, it can treat the sewage passing through the overflow water passage before it is discharged into a river or the like, and hence discharges the sewage in a condition of low environmental load, even when the water level abnormally rises.

Still more, the present invention uses a halide or halide ion for the electrochemical treatment, thereby further increasing production of a hypohalogenous acid, ozone or activated oxygen in the electrochemical treatment and enhancing sewage treatment efficiency.

Still more, the present invention uses seawater for the electrochemical treatment, thereby further increasing production of a hypohalogenous acid, ozone or activated oxygen in the electrochemical treatment by utilizing the seawater components.

Still more, the present invention adjusts the sewage at a pH of 7 or less to keep the hypohalogenous acid, ozone or activated oxygen, produced in the sewage to be treated, highly oxidative, thereby enhancing sewage treatment efficiency.

Still more, the present invention is provided with the electrodes of bi-polar type for electrolysis, which secures a larger number of the electrodes for electrolysis for unit volume of the sewage to be treated, thereby further enhancing sewage treatment efficiency. Moreover, the bi-polar type can work with a much reduced number of the terminals, thereby enhancing reliability of the system itself.

Still more, the present invention is provided with the electrodes of a noble metal or conductor coated with the noble metal, carbon-based conductor or conductor coated with the carbon-based conductor, ceramic-based conductor or conductor coated with the ceramic-based conductor, or iron-based alloy or conductor coated with the iron-based alloy. Therefore, it can easily produce a hypohalogenous acid, ozone or activated oxygen in the sewage, thereby treating the sewage effectively.

Still more, the treating means of the present invention is provided with a discharged water quantity sensor which senses a quantity of the sewage discharged from the discharge port at an overflow water passage provided in the sewer system to directly discharge the sewage as the CSO flowing under an abnormal condition into a river, sea or the like, when the water level rises abnormally; water quality sensor which senses quality of the sewage discharged from the discharge port; electrodes for electrolysis; and controller which controls current or/and voltage for electrolysis to be applied to the electrodes for electrolysis, based on externally supplied rainfall data, discharged quantity data read by the discharged water quantity sensor and water quality read by the water quality sensor. As such, it electrochemically treats the sewage flowing in the overflow water passage effectively, based on a quality and quantity of the sewage being discharged, thereby enhancing sewage treatment efficiency.

Still more, the combined sewer system of the present invention is composed of 2 or more lines, where the discharged water quantity sensor, water quality sensor and electrodes are provided for each line, and the controller controls current or/and voltage to be applied to the electrodes for electrolysis, based on externally supplied rainfall data, discharged quantity data read by the discharged water quantity sensor and water quality read by the water quality sensor. As such, the lines in the combined sewer system can be controlled in a centralized manner, thereby further enhancing its usefulness.

Still more, the present invention transmits data by the controller from a portable terminal to a server, and treats the data by the server by comparing them with meteorological data, and transmits necessary control signals selected from the past and present data and anticipated weather condition changes back to the portable terminal, to control current or/and voltage for electrolysis to be applied to the electrodes for electrolysis. As a result, the data regarding a water quality and a discharged water quantity can be collected by the portable terminal provided at the discharge port in each of the overflow water passages, to simplify the system structure.

What is claimed is:

1. A method for treating sewage in a combined sewer system where wastewater and rainwater collected flow together as sewage, comprising a step of treating the sewage with an electrochemically produced hypohalogenous acid, ozone or activated oxygen.

2. The method for treating sewage in the combined sewer system according to claim 1, wherein electrolytic water containing an electrochemically produced hypohalogenous acid, ozone or activated oxygen is mixed with the sewage.

3. The method for treating sewage in the combined sewer system according to claim 1 or 2, wherein the sewage is treated with a hypohalogenous acid, ozone or activated oxygen electrochemically produced therein.

4. The method for treating sewage in the combined sewer system according to claim 3, wherein part or all of the sewage is held for a while, electrochemically treated to produce a hypohalogenous acid, ozone or activated oxygen, and then discharged into the sewer system.

5. The method for treating sewage in the combined sewer system according to claim 4, wherein the sewage stored for a while is rainwater stored in a rainwater-reservoir system.

6. The method for treating sewage in the combined sewer system according to claim 3, wherein the sewage in the sewer system is treated with a hypohalogenous acid, ozone or activated oxygen electrochemically produced therein, and part or all of the treated sewage is stored for a while and discharged into the sewer system.

7. The method for treating sewage in the combined sewer system according to claim 6, wherein the sewage stored for a while is electrochemically treated to produce a hypohalogenous acid, ozone or activated oxygen therein, and then discharged into the upstream of the sewer system.

8. The method for treating sewage in the combined sewer system according to claim 3, 4, 5, 6 or 7, wherein the sewage is treated with a hypohalogenous acid, ozone or activated oxygen electrochemically produced therein at a pump station which pumps up the sewage flowing downward from the upstream of the sewer system up to the vicinity of the earth surface by a pump.

9. The method for treating sewage in the combined sewer system according to claim 3, 4, 5, 6, 7 or 8, wherein the sewage is treated with a hypohalogenous acid, ozone or activated oxygen electrochemically produced therein at an overflow water passage provided in the sewer system to directly discharge the sewage as the combined sewer overflow flowing under an abnormal condition into a river, sea or the like, when the water level rises abnormally.

10. The method for treating sewage in the combined sewer system according to 1, 2, 3, 4, 5, 6, 7, 8 or 9, wherein a halide or halide ion is added thereto for the electrochemical treatment.

11. The method for treating sewage in the combined sewer system according to 1, 2, 3, 4, 5, 6, 7, 8, 9 or 10, wherein seawater is added thereto in the electrochemical treatment.

12. The method for treating sewage in the combined sewer system according to 1, 2, 3, 4, 5, 6, 7, 8, 9, 10 or 11, wherein the sewage is adjusted at a pH of 7 or less.

13. A sewage treatment system in a combined sewer system where wastewater and rainwater collected flow together as sewage, comprising a treating means which electrochemically produces a hypohalogenous acid, ozone or activated oxygen with which the sewage is treated.

14. The sewage treatment system in the combined sewer system according to claim 13, wherein the treating means mixes electrolytic water containing an electrochemically produced hypohalogenous acid, ozone or activated oxygen with the sewage.

15. The sewage treatment system in the combined sewer system according to claim 13 or 14, wherein the treating means electrochemically treats the sewage to produce a hypohalogenous acid, ozone or activated oxygen therein.

16. The sewage treatment system in the combined sewer system according to claim 15 which comprises a reservoir which holds part or all of the sewage for a while, wherein
the treating means electrochemically treats the sewage held in the reservoir to produce a hypohalogenous acid, ozone or activated oxygen therein, and discharges the treated sewage into the sewer system.

17. The sewage treatment system in the combined sewer system according to claim 16, wherein the reservoir is a rainwater-reservoir which holds rainwater.

18. The sewage treatment system in the combined sewer system according to claim 16, wherein the reservoir is composed of an auxiliary chamber which is an expanded part of the sewer pipe for the sewer system.

19. The sewage treatment system in the combined sewer system according to claim 18, wherein a filter is provided between the sewer pipe and auxiliary chamber.

20. The sewage treatment system in the combined sewer system according to claim 15, wherein the treating means electrochemically treats the sewage flowing in the sewer pipe to produce a hypohalogenous acid, ozone or activated oxygen therein, and in a latter stage of the treating means, there is provided a reservoir which stores part or all of the sewage flowing in the sewer pipe for a while and discharges the treated sewage into the sewer system.

21. The sewage treatment system in the combined sewer system according to claim 20, wherein the treating means electrochemically treats the sewage stored in the reservoir to produce a hypohalogenous acid, ozone or activated oxygen therein, and discharges the treated sewage into the upstream of the sewer system.

22. The sewage treatment system in the combined sewer system according to claim 21, wherein the reservoir is composed of a storing chamber for storing the sewage and an electrolysis chamber for electrochemically treating the sewage in the reservoir.

23. The sewage treatment system in the combined sewer system according to claim 15, 16, 17, 18, 19, 20, 21 or 22, wherein the treating means also electrochemically treats the sewage to produce a hypohalogenous acid, ozone or activated oxygen therein at a pump station which pumps up the sewage flowing downward from the upstream of the sewer system up to the vicinity of the earth surface by a pump.

24. The sewage treatment system in the combined sewer system according to claim 15, 16, 17, 18, 19, 20, 21, 22 or 23, wherein the treating means electrochemically treats the sewage to produce a hypohalogenous acid, ozone or activated oxygen therein at an overflow water passage provided in the sewer system to directly discharge the sewage as the combined sewer overflow flowing under an abnormal condition into a river, sea or the like, when the water level rises abnormally.

25. The sewage treatment system in the combined sewer system according to claim 13, 14, 15, 16, 17, 18, 19, 20, 21, 22, 23 or 24, wherein the treating means is provided with means for adding a halide or halide ion to the electrochemically treated sewage.

26. The sewage treatment system in the combined sewer system according to claim 13, 14, 15, 16, 17, 18, 19, 20, 21, 22, 23, 24 or 25, wherein the treating means is provided with means for adding seawater to the electrochemically treated sewage.

27. The sewage treatment system in the combined sewer system according to claim 13, 14, 15, 16, 17, 18, 19, 20, 21, 22, 23, 24, 25 or 26, wherein the treating means is provided with pH-adjusting means for adjusting the electrochemically treated water at a pH of 7 or less.

28. The sewage treatment system in the combined sewer system according to claim 13, 14, 15, 16, 17, 18, 19, 20, 21, 22, 23, 24, 25, 26 or 27, wherein the treating means is provided with electrodes for electrolysis, the electrodes being of bi-polar type.

29. The sewage treatment system in the combined sewer system according to claim 13, 14, 15, 16, 17, 18, 19, 20, 21, 22, 23, 24, 25, 26, 27 or 28, wherein the treating means is provided with electrodes for electrolysis, each electrode being composed of a noble metal or conductor coated with the noble metal, carbon-based conductor or conductor coated with the carbon-based conductor, ceramic-based conductor or conductor coated with the ceramic-based conductor, or iron-based alloy or conductor coated with the iron-based alloy.

30. The sewage treatment system in the combined sewer system according to claim 13, 14, 15, 16, 17, 18, 19, 20, 21, 22, 23, 24, 25, 26, 27, 28 or 29, wherein the treating means is provided with a discharged water quantity sensor which senses a quantity of the sewage discharged from the discharge port at an overflow water passage provided in the sewer system to directly discharge the sewage as the combined sewer overflow flowing under an abnormal condition into a river, sea or the like, when the water level rises abnormally;
a water quality sensor which senses quality of the sewage discharged from the discharge port;
electrodes for electrolysis; and
a controller which controls current or/and voltage for electrolysis to be applied to the electrodes for electrolysis, based on externally supplied rainfall data, discharged quantity data read by the discharged water quantity sensor and water quality data read by the water quality sensor.

31. The sewage treatment system in the combined sewer system according to claim 30, wherein the sewer system is composed of two or more lines,
each sewer system line being provided with a discharged water quantity sensor, water quality sensor and electrodes for electrolysis; and
the controller is also provided to control current or/and voltage for electrolysis to be applied to the electrodes for electrolysis, based on externally supplied rainfall data, discharged quantity data read by each discharged water quantity sensor and water quality data read by each water quality sensor.

32. The sewage treatment system in the combined sewer system according to claim 30 or 31, wherein the controller transmits data from a portable terminal to a server, which treats the data by comparing them with meteorological data, and transmits necessary control signals selected from the past and present data and anticipated weather condition changes back to the portable terminal, to control current or/and voltage for electrolysis to be applied to the electrodes for electrolysis.
